(19) United States
(12) Patent Application Publication
(10) Pub. No.: US 2015/0136944 A1
(43) Pub. Date: May 21, 2015

(54) SUNLIGHT TRACKING SENSOR AND SYSTEM

(71) Applicant: Avraham Segev, Atlit (IL)

(72) Inventor: Avraham Segev, Atlit (IL)

(21) Appl. No.: 14/085,977

(22) Filed: Nov. 21, 2013

(51) Int. Cl. G01S 3/786

(52) U.S. Cl. CPC G01S 3/7861
USPC 250/203.4

(57) ABSTRACT

A sunlight tracking sensor, comprising: a base; a gyroscopic mechanism, for rotating the base; a non-transparent cylindrical profile, mounted on the base; a first pair of punctual light intensity sensors, mounted on the base from opposite sides of the horizontal axis, at an outer side of the cylindrical profile; a second pair of punctual light intensity sensors mounted on the base from opposite sides of the vertical axis, at an outer side of the cylindrical profile; wherein the gyroscopic mechanism comprises: a first rotating mechanism, correspondingly with the first pair of punctual sensors, for rotating the base around the horizontal axis; a second rotating mechanism, correspondingly with the second pair of punctual sensors, for rotating the base around a vertical axis; a controller, for instructing each of the rotating mechanisms to adjust its orientation towards the sensor of the corresponding pair of sensors, which indicate a higher light intensity level.

### TECHNICAL FIELD

The present invention relates to the field of sunlight tracking systems.

### BACKGROUND ART

Solar receptors (panels) are usually in the form of a plane on which are disposed a plurality of light sensors. The best mode to align such receptors is perpendicularly to the sunlight radiation, where the radiation is maximal. As the sun changes its location with regard to the earth, such sensor must be able to track the change.

In the prior art, some systems for solving this problem have been developed over the years, but they are not accurate “enough”; and cumbersome, expensive and limited in their performance.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a sunlight tracking sensor (10), comprising:

a base (56);

a gyroscopic mechanism, rotatable around a horizontal axis (52), and around a vertical axis (54);

a non-transparent cylindrical profile (26), mounted on the base (56);

a first pair of punctual light intensity sensors (12a, 12c), mounted on the base (56) from opposite sides of the horizontal axis (52), at an outer side of the cylindrical profile (26);

a second pair of punctual light intensity sensors (12b, 12b) mounted on the base (56) from opposite sides of the vertical axis (54), at an outer side of the cylindrical profile (26);

wherein the gyroscopic mechanism comprises:
a first rotating mechanism (42), correspondingly with the first pair of punctual sensors (12a,12c), for rotating the base (56) around the horizontal axis (52);
a second rotating mechanism (44), correspondingly with the second pair of punctual sensors (12b,12d), for rotating the base (56) around a vertical axis (54);

a controller (40), for instructing each of the rotating mechanisms (42, 44) to adjust its orientation towards the sensor of the corresponding pair of sensors, which indicate a higher light intensity level;

thereby providing a mechanism for roughly adjusting a position of the cylindrical profile towards the sunbeams.

The sunlight tracking sensor (10) may further comprise:

an areal sensor (36) mounted in an inner side of the cylindrical profile (26);

an optical system (22), mounted on the cylindrical profile, for focusing sunbeams on the areal sensor (36);

an adaption of the controller to rotate the mechanisms to bring the sunbeams to focus on the center of the areal sensor;

thereby providing a mechanism for refining a position of the cylindrical profile towards the sunbeams in a relatively high accuracy.

According to one embodiment of the invention, the punctual sensors (12a, . . . , 12d) are disposed adjacently to the cylindrical profile (26), thereby increasing a sensitivity of the adjusting mechanism for roughly adjusting a position of the cylindrical profile towards the sunbeams.

The sunlight tracking sensor (10) may further comprise walls (14) separating between the punctual sensors.

According to one embodiment of the invention, the sunlight tracking sensor (10) is installed on an object (48) such that the position thereof has to be adjusted with regard to sunbeams, such that the gyroscopic mechanism serves both the sensor (10) and the object (48).

According to another embodiment of the invention, the sunlight tracking sensor (10) controls an object (48) installed remotely to the sensor (10).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a front view of a sunlight tracking sensor, according to one embodiment of the invention.

FIG. 2 is a back view thereof.

FIG. 3 is a front view on a sunlight tracking sensor 10 of FIG. 1, from which lens 22 has been “removed”.

FIG. 4 is a sectional view schematically illustrating the sunlight tracking sensor of FIG. 1 in a situation wherein the sensor is diverted from the sunlight.

FIG. 5 is a sectional view schematically illustrating the sunlight tracking sensor of FIG. 1 in a situation wherein the sensor is in the optimal situation with regard to the sun beams.

FIG. 6 is a sectional view schematically illustrating the sunlight tracking sensor of FIG. 1 in a situation wherein the sensor is slightly diverted from the optimal situation with regard to the sunlight.

FIG. 7 schematically illustrates a sunlight tracking system 50, according to one embodiment of the invention.

FIG. 8 schematically illustrates a sunlight tracking system, according to another embodiment of the invention.

FIG. 9 is a front view on a sunlight tracking sensor, according to another embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

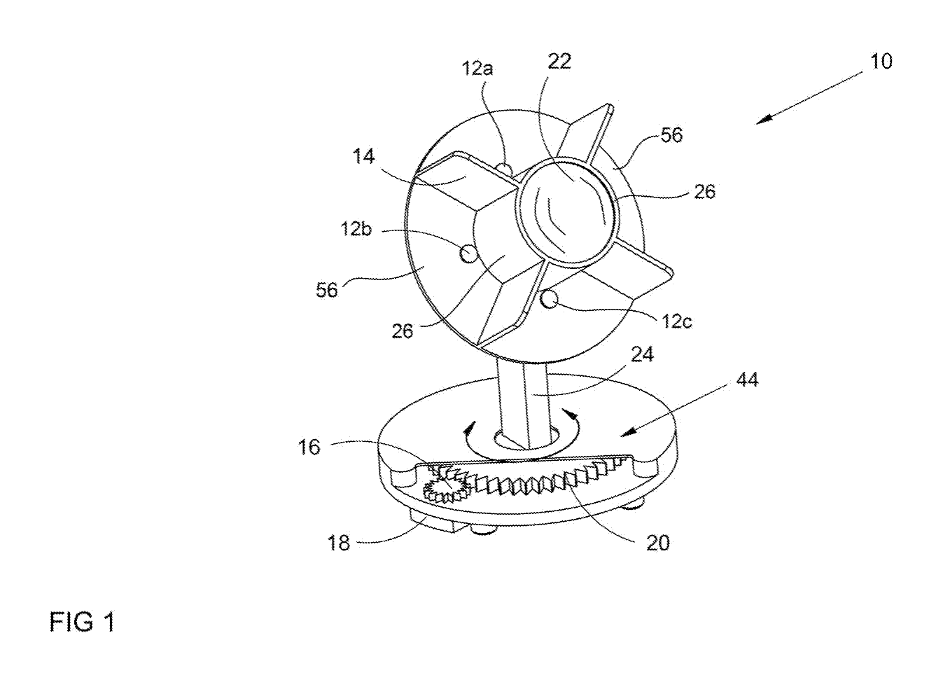

FIG. 1 is a front view of a sunlight tracking sensor, according to one embodiment of the invention.

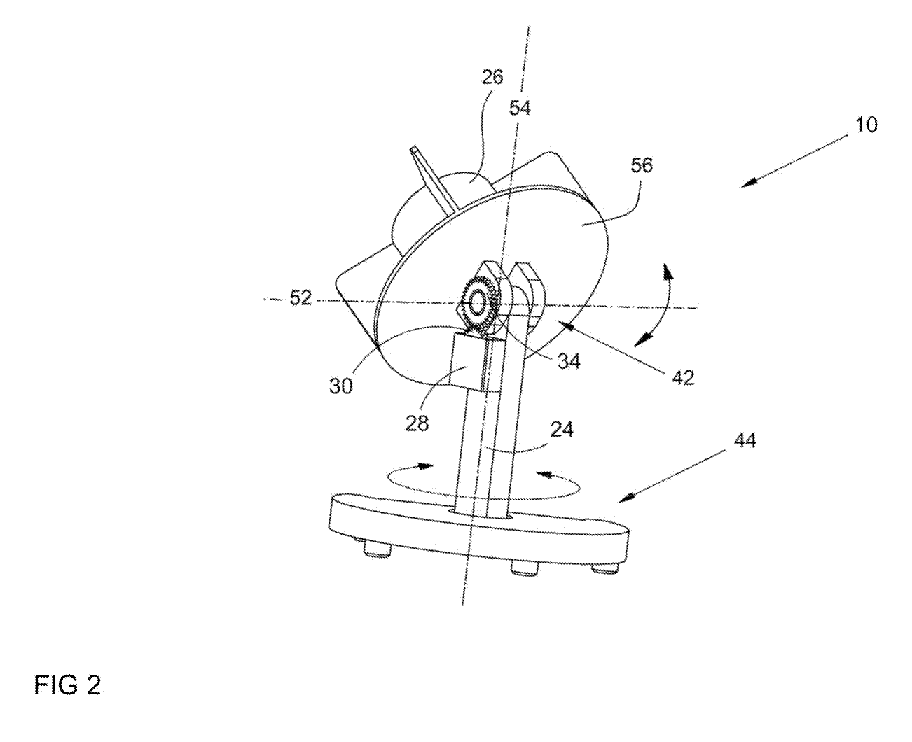

FIG. 2 is a back view thereof.

The sunlight tracking sensor, which is marked herein by reference numeral 10, comprises a non-transparent cylindrical wall 26, and four light sensors 12i (i=a, . . . , d) disposed there around, preferably near the cylindrical wall 26, from the outer side of the cylindrical wall 26. Sensor 12a is disposed at the upper side of the cylindrical wall; sensor 12c is disposed at the bottom side of thereof, sensor 12b is disposed at the right side thereof; and sensor 12d is disposed at the left side thereof. Optionally, planar walls 14 separate between sensors 12i.

The set of sensors 12i along with walls 26 and 14 are disposed on a base 56 which in this case is in a form of a plate. Thus, sensors 12i, and walls 14 and the cylindrical wall 26 move along with base 56.

Sunlight tracking sensor 10 also comprises a gyroscopic mechanism for changing the orientation of base 56 (along with sensors 12i, walls 14, and cylindrical wall 26). The gyroscopic mechanism comprises a first mechanism 42 for rotating base 56 around a horizontal axis 52, and a second mechanism for rotating base 56 around a vertical axis 54.

More particularly, the gyroscopic mechanism comprises a first motor 28 which rotates base 56 around the horizontal axis 52, and a second motor 18 which rotates base 56 around the vertical axis 54.

More particularly, as per the rotation around the vertical axis 54, motor 18 rotates cogwheel 16 (seen in FIG. 1), which rotates pole 24 through which the vertical axis 54 passes. As per the rotation around the horizontal axis 52, motor 28 rotates cogwheel 30 (seen in FIG. 2), which rotates cogwheel 34 through which the horizontal axis 52 passes.

The object of walls 26 and 14 is to generate shaded areas in the location of sensors 12i in a situation wherein the orientation of sunlight tracking sensor 10 is not optimal, i.e., is not parallel to the sunlight beams. Under such conditions, a gyroscopic mechanism can be directed to change the orientation of sensor 10 as follows:

If the light intensity of the upper sensor 12a is higher than the light intensity of the lower sensor 12c, then base 56 is rotated (along the horizontal axis 52) towards sensor 12a, and vice versa.

If the light intensity of the right sensor 12d is higher than the light intensity of the left sensor 12b, then base 56 is rotated (along the vertical axis 54) towards sensor 12d, and vice versa.

Thus, the gyroscopic mechanism has to rotate base 56 towards the sensor with the higher light intensity of two opposite sensors. In this particular case, as one motor rotates the plate around a horizontal axis 52, and the other rotates the plate around a vertical axis 54, it is preferred to place sensors 12i one above the other (12a, 12c), and one on the right of the other (12b, 12d).

Generalizing this concept, assuming the gyroscopic mechanism rotates base 56 around a vertical axis and a horizontal axis, then the base has to be rotated towards the higher/lower and left/right side from which its sensors sense higher light intensity.

Sensors 12i provide a rough indication about the correct orientation of sunlight tracking sensor 10. In order to provide a more accurate indication, a lens 22 (seen in FIG. 1) and an areal sensor 36 are employed. In contrast to sensors 12i, which only sense the light intensity in a point, areal sensor 36 senses the light intensity in a plurality of points of an areal. In other words, while each of sensors 12i is in the form of a function i=f( ), (wherein i is light intensity), areal sensor 36 is in the form of a function i=f(x,y), (wherein (x,y) denotes a location of the areal).

Actually, in the areal are installed a certain number of light sensors; however, the light intensity can be calculated by interpolation means for each point (x,y) in the areal, even if no sensor is present in this point.

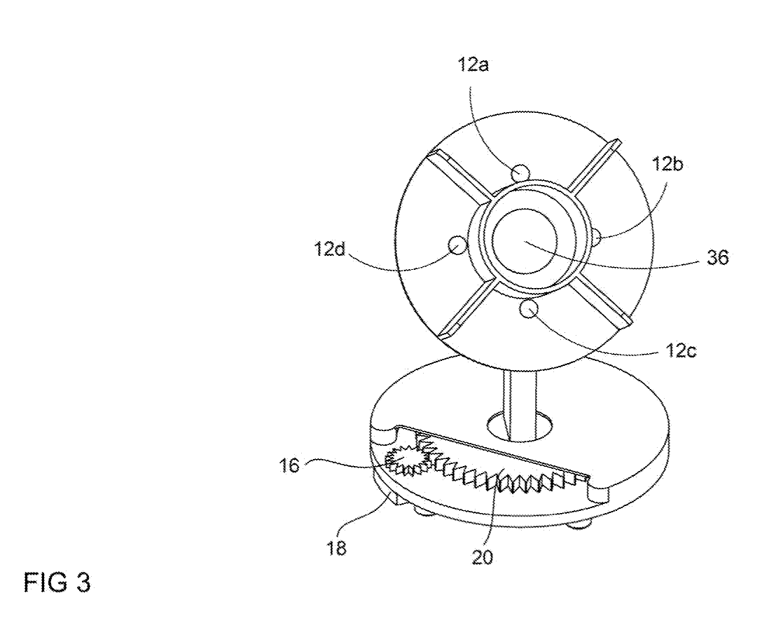

FIG. 3 is a front view on a sunlight tracking sensor 10 of FIG. 1, from which lens 22 has been “removed”.

If lens 22 is convex, and the areal sensor 36 is disposed in its focus, the sunlight is concentrated on the areal sensor. In this way, the orientation of sunlight tracking sensor 10 can be refined to the desired orientation. Actually, lens 22 is merely an example, and more sophisticated optical systems can be used in order to obtain high accuracy.

Thus, two stages of aligning sunlight tracking sensor 10 in the desired orientation are provided: a first stage in which the orientation of sensor 10 towards the sun can be adjusted roughly, and a second stage in which the orientation of sensor 10 towards the sun can be adjusted in a higher accuracy.

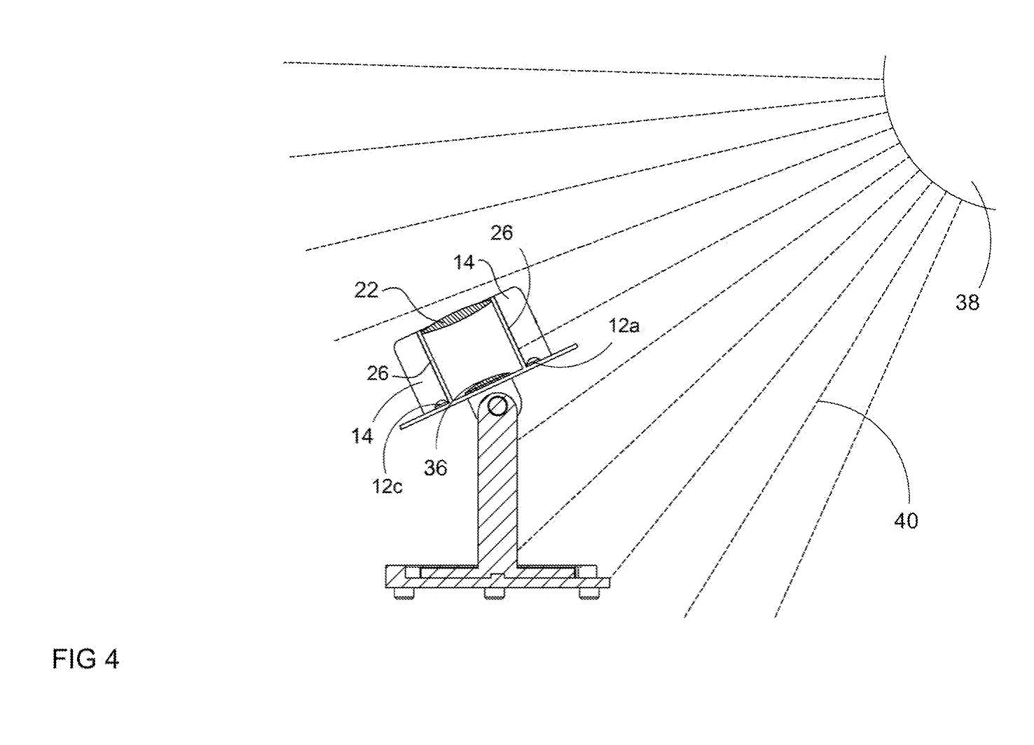

FIG. 4 is a sectional view schematically illustrating the sunlight tracking sensor of FIG. 1 in a situation wherein the sensor is diverted from the sunlight.

In this situation, sensor 12a receives a substantial amount of sunlight in comparison to sensor 3c. As such, the required rotation around the horizontal axis is clockwise (according to the figure's orientation). It should be noted that in this situation, areal sensor 36 is useless, since no sunbeams meet lens 22.

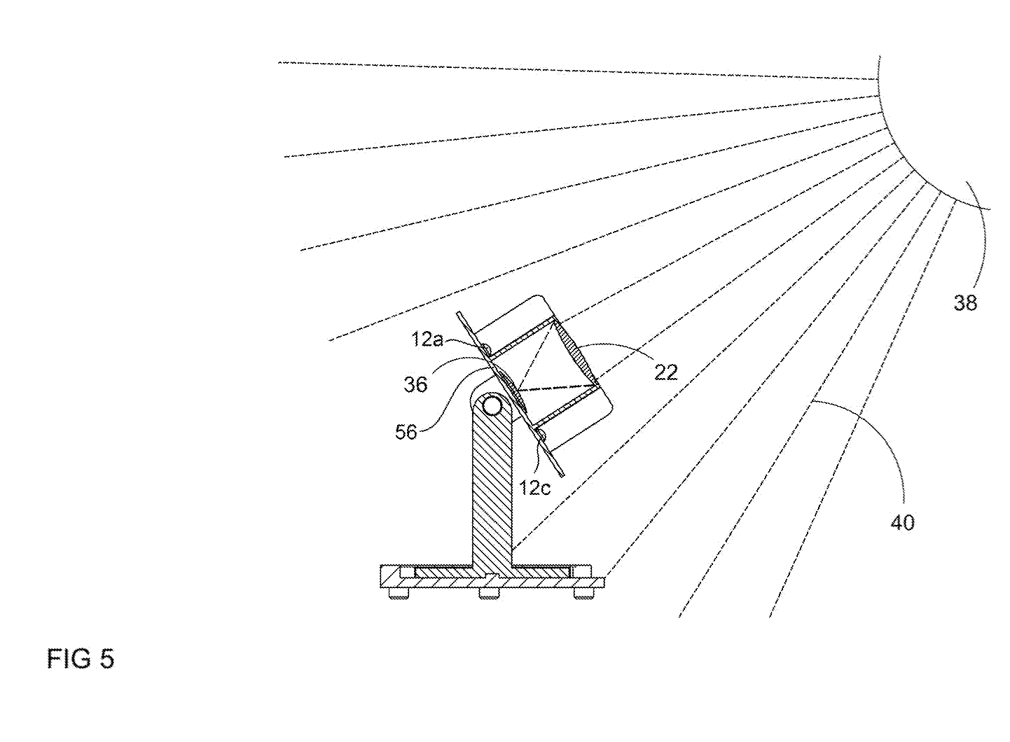

FIG. 5 is a sectional view schematically illustrating the sunlight tracking sensor of FIG. 1 in a situation wherein the sensor is in the optimal situation with regard to the sunbeams.

In this situation, the sunbeams are concentrated to the center of areal sensor 36.

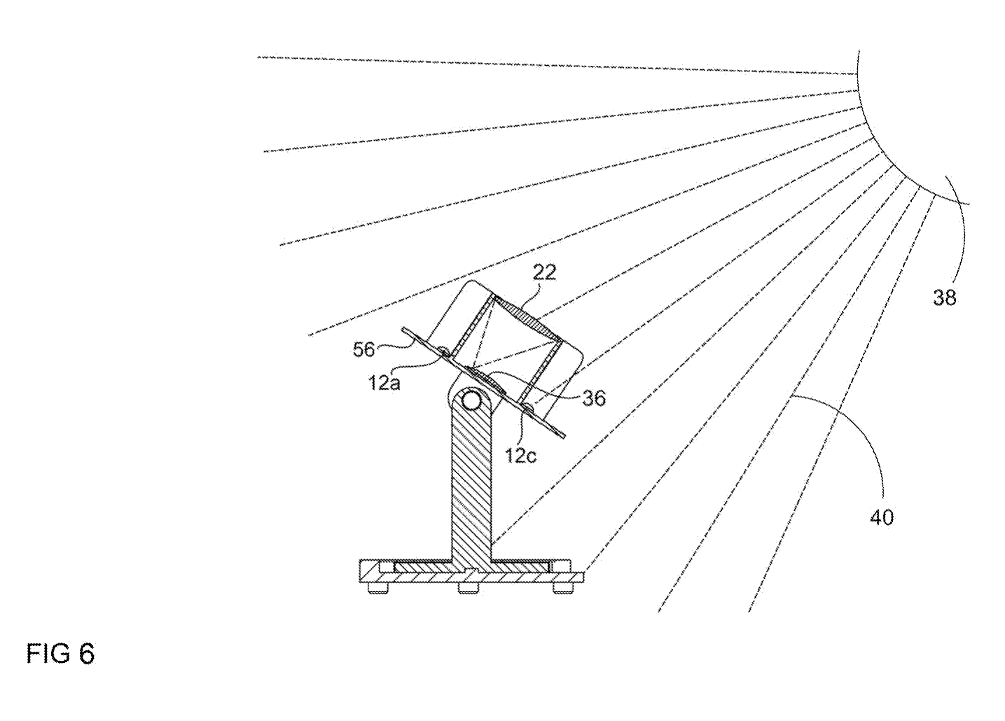

FIG. 6 is a sectional view schematically illustrating the sunlight tracking sensor of FIG. 1 in a situation wherein the sensor is slightly diverted from the optimal situation with regard to the sunlight.

In this situation, sensor 12a is shaded, and therefore the light intensity it senses is less than the light intensity sensed by the opposite sensor 12c. Furthermore, the concentration of the sunbeams on areal sensor 36 is diverted from the center of the areal sensor. Thus, under this situation, the gyroscopic mechanism can be directed to rotate according to readings of both sensor 12i, and of areal sensor 36.

It should be noted that in FIGS. 4 to 6, the sunlight beams have not been illustrated as parallel beams, for pictorial reasons.

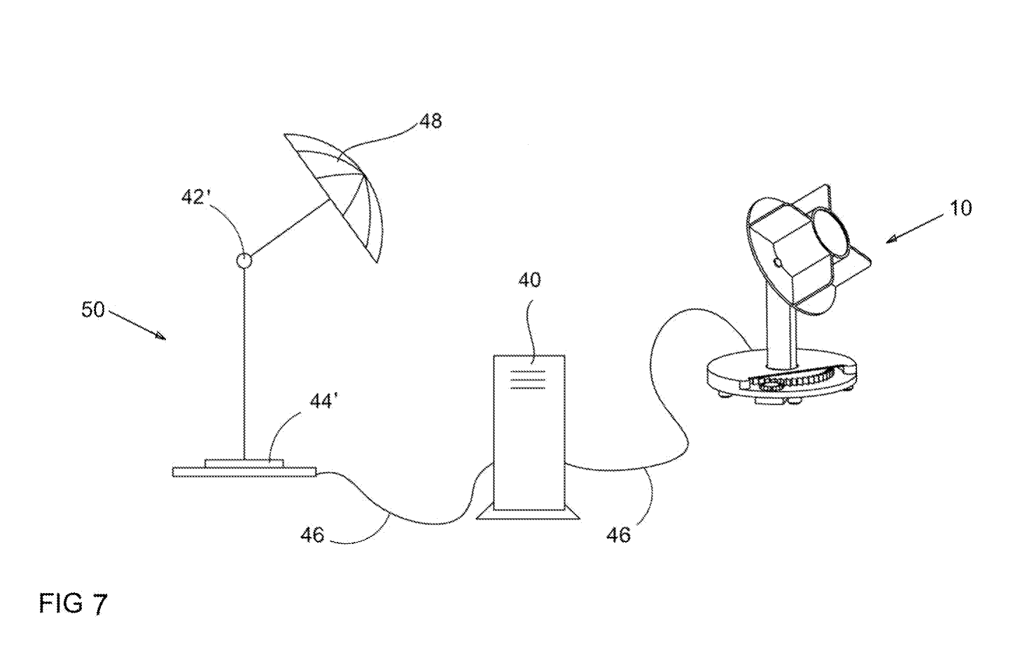

FIG. 7 schematically illustrates a sunlight tracking system 50, according to one embodiment of the invention.

Reference numeral 50 denotes a sunlight tracking system that comprises an object 48, such as an umbrella canopy and a solar panel, to be turned towards the sun. The system is operated by a gyroscopic mechanism (mechanisms 42′, 44′) correspondingly to the first gyroscopic mechanism (mechanisms 42, 44) of the sunlight tracking sensor 10.

Sunlight tracking system 50 also employs a sunlight tracking sensor 10, connected by wired or wireless communication 46 to a controller 40, which controls the operation of turning object 48, which in this case is an umbrella canopy, towards the sun.

The gyroscopic mechanism of system 50 employs a first mechanism 42′ for rotating the umbrella canopy around a horizontal axis, and a second mechanism 44′ for rotating the umbrella canopy around a vertical axis. The controller 40 sends to the gyroscopic mechanism instructions to rotate its rotation mechanisms 42′ and 44′ correspondingly to the rotation of rotation mechanisms 42 and 44 of the gyroscopic mechanism of the sunlight tracking sensor 10.

Once the sunlight tracking system 50 is calibrated, i.e., umbrella canopy 48 is directed to the same direction as sensor 10, every movement of sensor 10 is repeated by umbrella canopy 48, thereby tracking the sunlight.

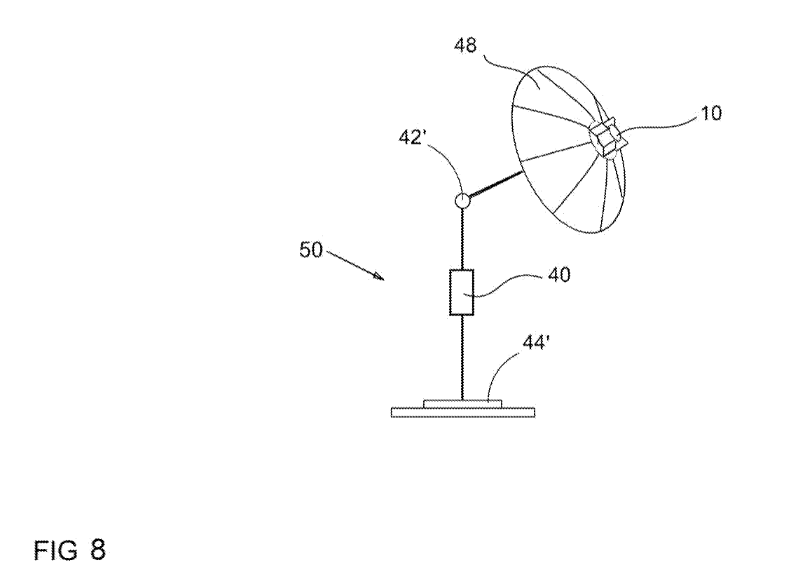

FIG. 8 schematically illustrates a sunlight tracking system, according to another embodiment of the invention.

According to this embodiment of the invention, sunlight tracking sensor 10 is installed on umbrella canopy 48 of the sunlight tracking system 50, and both sensor 10 and tracking system 50 use the same gyroscopic. As a result, the gyroscopic mechanisms 42′, 44′ turn both sensor 10 and umbrella canopy 48 to the same direction. Thus, as the orientation of sensor 10 towards the sun changes, the orientation of canopy 48 towards the sun also changes.

The umbrella is merely an example, and the invention can be implemented on a wide range of applications, including solar panels.

The difference between the embodiment of FIG. 7 and the embodiment of FIG. 8 is that, while in the embodiment of FIG. 8 each controlled device 48 uses a dedicated sensor 10, in the embodiment of FIG. 7 a single sunlight tracking sensor 10 controls a plurality of devices 48. As such, the embodiment of FIG. 7 is suited to, for example, a solar panel farm. On the other hand, calibrating the system of FIG. 8 is easier, and both, sensor 10 and the controlled device use the same gyroscopic mechanism.

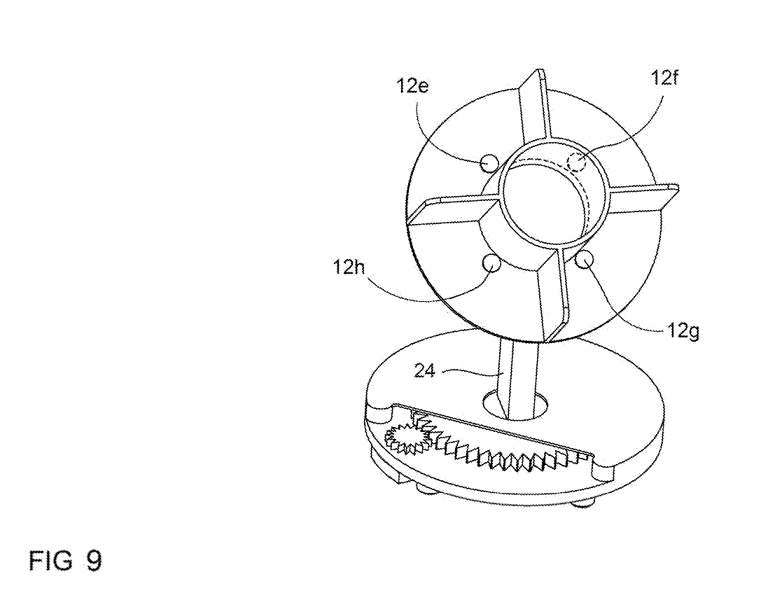

FIG. 9 is a front view on a sunlight tracking sensor, according to another embodiment of the invention.

If the sensors are not disposed in this order, as illustrated in FIG. 9, the average light intensity of the upper sensors (12e, 12f) is considered as the sensing of the high sensor, and the average light intensity of the lower sensors (12g, 12h) is considered as the sensing of the low sensor; the average light intensity of the sensors on the left (12e, 12h) is considered as the sensing of the left sensor, and the average light intensity of the sensors on the right (12f, 12g) is considered as the sensing of the right sensor.

In the figures and/or description herein, the following reference numerals (Reference Signs List) have been mentioned:

numeral 10 denotes a sunlight tracking sensor, according to one embodiment of the invention;

each of numerals 12i (i=a, . . . , d) denotes a “punctual” light sensor, such as a solar cell (also called a photovoltaic cell), that measures light intensity in a spot;

numeral 14 denotes a septum (wall);

numeral 16 denotes a cogwheel (connected to motor 18) which is a part of a transmission;

numeral 18 denotes a motor, for rotating base 56 of sensor 10 around vertical axis 54;

numeral 20 denotes a cogwheel which is a part of a transmission;

numeral 22 denotes a lens, as an example of an optical system mounted on cylindrical profile 26;

numeral 24 denotes a pole which embodies vertical axis 54;

numeral 26 denotes a cylindrical profile (wall);

numeral 28 denotes a motor, for rotating base 56 of sensor 10 around a horizontal axis 52;

numeral 30 denotes a cogwheel (connected to motor 28) which is a part of a transmission;

numeral 34 denotes a cogwheel which rotates base 56 around horizontal axis 52;

numeral 36 denotes “areal” sensor (in contrast to a “punctual” sensor;

numeral 38 denotes the sun;

numeral 40 denotes a controller;

numeral 42 denotes a mechanism for rotating sensor 10 around a horizontal axis 52;

numeral 42′ denotes a mechanism that performs the operation of mechanism 42, on a remote device;

numeral 44 denotes a mechanism for rotating sensor 10 around a vertical axis 54;

numeral 44′ denotes a mechanism that performs the operation of mechanism 44, on a remote device;

numeral 46 denotes a communication channel, whether wired or wireless;

numeral 48 denotes a canopy of an umbrella, as an example of an object (such as a solar panel, an umbrella, and so on) to be turned towards the sun;

numeral 50 denotes a sunlight tracking system for turning object 48 towards the sun, that comprises a gyroscopic mechanism that employs mechanisms 42′ and 44′, such as mechanisms 42 and 44 of the gyroscopic system of sensor 10;

numeral 52 denotes an horizontal axis;

numeral 54 denotes a vertical axis; and

numeral 56 denotes a base (chassis) of sensor 10.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A sunlight tracking sensor (10), comprising:
a base (56);
a gyroscopic mechanism for rotating said base, said gyroscopic mechanism being rotatable around a horizontal axis (52), and around a vertical axis (54);
a non-transparent cylindrical profile (26), mounted on said base (56);
a first pair of punctual light intensity sensors (12a, 12c), mounted on said base (56) from opposite sides of said horizontal axis (52), at an outer side of said cylindrical profile (26);
a second pair of punctual light intensity sensors (12b, 12b) mounted on said base (56) from opposite sides of said vertical axis (54), at an outer side of said cylindrical profile (26);
wherein said gyroscopic mechanism comprises:
a first rotating mechanism (42), correspondingly with said first pair of punctual sensors (12a,12c), for rotating said base (56) around said horizontal axis (52);
a second rotating mechanism (44), correspondingly with said second pair of punctual sensors (12b,12d), for rotating said base (56) around a vertical axis (54);
a controller (40), for instructing each of said rotating mechanisms (42, 44) to adjust its orientation towards the sensor of the corresponding pair of sensors, which indicate a higher light intensity level;
thereby providing a mechanism for roughly adjusting a position of said cylindrical profile towards said sunbeams.

2. A sunlight tracking sensor (10) according to claim 1, further comprising:
an areal sensor (36) mounted in an inner side of said cylindrical profile (26);
an optical system (22), mounted on said cylindrical profile, for focusing sunbeams on said areal sensor (36);
an adaption of said controller to rotate said mechanisms to bring the sunbeams to focus on the center of said areal sensor;
thereby providing a mechanism for refining a position of said cylindrical profile towards said sunbeams in a relatively high accuracy.

3. A sunlight tracking sensor (10) according to claim 1, wherein said punctual sensors (12a, . . . , 12d) are disposed adjacently to said cylindrical profile (26), thereby increasing a sensitivity of the adjusting mechanism for roughly adjusting a position of said cylindrical profile towards said sunbeams.

4. A sunlight tracking sensor (10) according to claim 1, further comprising walls (14) separating between said punctual sensors.

5. A sunlight tracking sensor (10) according to claim 1, installed on an object (48) such that the position thereof has to be adjusted with regard to sunbeams such that said gyroscopic mechanism serves both said sensor (10) and said object (48).

6. A sunlight tracking sensor (10) according to claim 1, that controls an object (48) installed remotely to said sensor (10).
